(19) United States
(12) Patent Application Publication
(10) Pub. No.: US 2012/0044846 A1
(43) Pub. Date: Feb. 23, 2012

(54) OPERATION OF A TELECOMMUNICATIONS SYSTEM

(75) Inventors: Stefan Ivanov Videv, Edinburgh (GB); Harald Haas, Edinburgh (GB); Rui Wang, Livingston (GB); John Thompson, Edinburgh (GB)

(73) Assignee: The University Court of the University of Edinburgh, Edinburgh (GB)

(21) Appl. No.: 13/197,422

(22) Filed: Aug. 3, 2011

(30) Foreign Application Priority Data
Aug. 17, 2010 (GB) 1013771.9

(51) Int. Cl. H04W 52/04; H04W 72/04

(52) U.S. Cl. 370/311; 370/329

(57) ABSTRACT

A method of operating a mobile telecommunications system having a base station, a plurality of users and a plurality of spectral resource blocks, some of which are not allocated to users. The method includes, (a) for each user, assigning a score to each resource block based on the energy efficiency with which the user can use the resource block, and determining which of the plurality of resource blocks is favored, i.e. has a score indicating that it will be the most energy efficient for the user. For each user, either (b) if the user's favored resource block is not allocated, and is not favored by any other user, that resource block is allocated to that user; or (c) in the event that the same resource block is favored by more than one user, it is allocated to the user who will use it with the greatest energy efficiency.

### BACKGROUND TO THE INVENTION

This invention relates to a method of operating a mobile telecommunications system and to a base station for implementing the method.

Much current research work is focused on joint efficient resource allocation and power control that minimize interference and maximize system capacity. Overall network capacity is adopted as the measure of system performance.

In contrast, the present invention is concerned with introducing a technique that preserves system performance while minimizing the expended energy.

F. Meshkati, V. Poor, and S. Schwartz, “Energy-Efficient Resource Allocation in Wireless Networks: An Overview of Game Theoretic Approaches,” IEEE Signal Processing Magazine: Special Issue on Resource-Constrained Signal Processing, Communications and Networking, May 2007, focuses on trade-offs between throughput, delay, network capacity and energy efficiency. However, the approaches analyzed assume no cooperation between users. Özgur Oyman and A. J. Paulraj, “Power-Bandwidth Tradeoff in Dense Multi-Antenna Relay Networks,” IEEE Transactions on Wireless Communications, vol. 6, pp. 2282-2293, June 2007, explores the power-bandwidth trade-off in dense multi-antenna relay networks. However, this work is based on multi-antenna relay beamforming, and is primarily focused on enhancing spectral efficiency rather than minimizing expended energy. S. Sinanovic, N. Serafimovski, H. Haas, and G. Auer, “Maximising the System Spectral Efficiency in a Decentralised 2-link Wireless Network,” Eurasip Journal on Wireless Communications and Networking, vol. 2008, p. 13, 2008, focuses on the effect of power allocation on spectral efficiency in 2-link decentralized networks. Their results are particularly interesting with regard to the effects interference has on spectral and hence energy efficiency. P. Omiyi, H. Haas, and G. Auer, “Analysis of TDD Cellular Interference Mitigation Using Busy-Bursts,” IEEE Transactions on Wireless Communications, vol. 6, no. 7, pp. 2721-2731, July 2007, proposes a novel interference avoidance technique based on in-band signaling that also has implications towards energy conservation. A good overview of energy efficient network protocols for wireless networks can be found in C. E. Jones, K. M. Sivalingam, P. Agrawal, and J. C. Chen, “A Survey of Energy Efficient Network Protocols for Wireless Networks,” Wireless Networks, vol. 7, pp. 343-358, 2001. The authors consider a variety of topics, including low-power design within the physical layer, sources of power consumption within the mobile terminals, energy efficient MAC protocols, as well as protocols on the transport and application layers.

The concept of an energy efficient “sleep mode” has been investigated in W. Ye, J. Heidemann, and D. Estrin, “An Energy-Efficient MAC Protocol for Wireless Sensor Networks,” INFOCOM 2002: Twenty-First Annual Joint Conference of the IEEE Computer and Communications Societies, Proceedings. IEEE, vol. 3, pp. 1567-1576, 2002 and K. Han and S. Choi, “Performance Analysis of Sleep Mode Operation in IEEE 802.16e Mobile Broadband Wireless Access Systems,” Vehicular Technology Conference, 2006: VTC 2006-Spring. IEEE 63rd, vol. 3, pp. 1141-1145, September 2006. These publications focus on an on/off approach to sleep cycles in decentralized networks. Mobile stations (MSs) are allowed to turn off for periods of time depending on the traffic conditions. There are algorithms which iteratively increase sleep time if there are no requests to the MS. R. Wang, J. Thompson, and H. Haas, “A Novel Time-Domain Sleep Mode Design for Energy-Efficient LTE,” International Symposium on Communications, Control and Signal Processing, March 2010, focuses on a more active approach, where energy is saved by cutting down on control signaling during low traffic periods.

### SUMMARY OF THE INVENTION

It is an aim of the invention to allocate resources in wireless networks in an energy efficient manner, thus potentially saving operational costs and CO₂ emissions.

The invention considers the users of a wireless system and allocates bandwidth resources in an energy-efficient manner for each user. It is particularly applicable to LTE (long term evolution) OFDMA (orthogonal frequency division multiple access) systems in which frequency resources are available in quantum resource blocks (RBs).

The invention uses an energy efficiency measure in the process of scheduling. The measure is used to calculate both a relative score for the RBs for a user, and a global score on energy efficiency considering all users. The scheduler increases the number of scheduled RBs, if proven to be more energy efficient, when the system is underloaded.

The present invention provides a method of operating a mobile telecommunications system having a base station, a plurality of users and a plurality of spectral resource blocks, some of which are not allocated to users, the method comprising (a) for each user, assigning a score to each resource block based on the energy efficiency with which the user can use the resource block, and determining which of the plurality of resource blocks is favored, i.e. has a score indicating that it will be the most energy efficient for the user; and for each user; either (b) if the user's favored resource block is not allocated, and is not favored by any other user, allocating that resource block to that user or (c) in the event that the same resource block is favored by more than one user, allocating it to the user who will use it with the greatest energy efficiency.

Calculation of the energy efficiency in step (a) may comprise calculating the transmission power, the energy per transmitted bit, the total required energy for a transmission or a combination of more than one of these.

The method may involve repeating steps (b) and (c) until either (i) all of the resource blocks have been allocated, or (ii) all users' QoS constraints have been satisified and no user's energy efficiency would be increased by a further resource block.

In order to avoid compromising the QoS (quality of service), resource blocks that cannot achieve a minimum signal-to-interference-to-noise ratio (SINR) may be removed from consideration in step (a).

To promote fairness, a penalty function of each user may be changed whenever the user is allocated a further resource block, the penalty function being used to modify the score and reduce the chance of that user being allocated further resource blocks. The penalty function may for example comprise a power of the number of resource blocks already allocated to a user or a constant raised to the power of that number.

The method may further include expanding a bandwidth footprint and reducing a modulation complexity of at least one user. In particular, from another aspect, the present invention provides a method of operating a mobile telecommunications system having a base station, a plurality of users and a plurality of spectral resource blocks, some of which are not allocated to users, the method comprising (p) determining whether there are free resource blocks; (q) if so, recalculating the scores for the free resource blocks according to step (a); (r) determining which of the users would increase the overall system energy efficiency most if the user's bandwidth were expanded; (s) determining that user's additional favored resource blocks) using the score recalculated in step (q) and (t) allocating the additional favored resource block(s) to the user and causing the user to enter an extended-bandwidth transmission mode. This may in particular involve expanding the user's total bandwidth by a factor that is a natural number and reducing the user's modulation complexity accordingly. Optionally, it may additionally involve manipulating other link parameters such as the coding scheme or coding rate.

The user entering extended-bandwidth transmission mode may be removed from consideration for a subsequent bandwidth expansion. Steps (p) to (t) may then be repeated until step (p) finds that there are no more free resource blocks.

The method of the invention may involve a power control routine which minimizes the signal strength allocated to each channel. This may be performed after step (c) and/or after step (t).

The invention also provides a base station adapted to perform the method set out above.

### BRIEF DESCRIPTION OF THE DRAWINGS

The invention will now be described in more detail, by way of example only, with reference to the accompanying drawings, in which:

FIG. 1 is a flow chart showing the method of the invention;

FIG. 2a schematically shows a scenario for two users;

FIG. 2b plots the required transmission power of the users of FIG. 2a under frequency selective fading;

FIG. 3 schematically shows a simulation scenario;

FIGS. 4a, 4b and 4c are graphs of data rate results;

FIG. 5 is a graph showing relative energy consumption gain; and

FIG. 6 shows the LTE frame structure.

### DETAILED DESCRIPTION OF PARTICULAR EMBODIMENTS

The invention employs a score-based scheduler. T. Bonald, “A Score-Based Opportunistic Scheduler for Fading Radio Channels,” in Proc. of the European Wireless Conference (EWC), Barcelona, Spain, Feb. 24-27 2004 has described a score-based scheduler that determines QoS or throughput. The scheduler of the invention, by contrast, aims at optimizing spectral efficiency, fairness and energy efficiency, whilst ensuring that the QoS is not compromised.

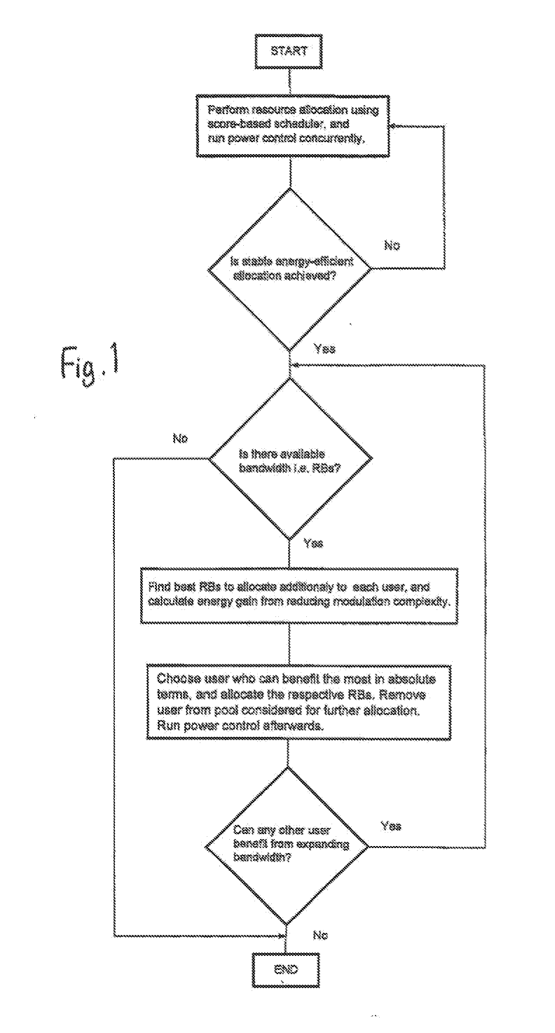

An overview of the operation of the proposed technique is presented in the form of a flowchart in FIG. 1. The allocation routine starts by using a score-based scheduler that relies on channel gains, interference characteristics and an energy metric to find the most energy-efficient resource blocks (RBs) to transmit on.

It is based on the following equation:

$${s}_{i}^{k} ( t ) = 1 + {\sum }_{j = 1 , j \neq i}^{W} {Π}_{{E}_{i}^{k} ( t ) > {E}_{j}^{k} ( t )} + {f}^{k} ( n ) \qquad ( 1 )$$

where sᵢ^{k}(t) is the score for RB i at time t for user k, W is the total number of RBs available for allocation to the user at the time, E: (t) is the energy metric for RB i at time t and user k, and f^{k}(n) is a penalty function for user k. Lower RB scores mean a RB is more likely to be allocated. The penalty function is used to further promote fairness in the system, as well as to provide convenient means to control the resource distribution.

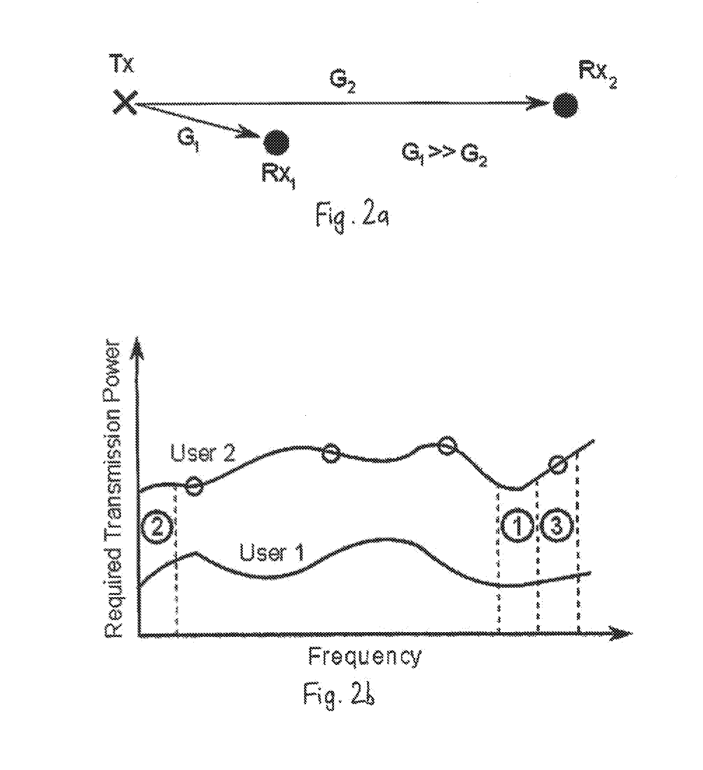

The energy metric can be any measure that assesses the energy performance of a wireless transmission. For example, it can be the transmission power required, the energy per transmitted bit, or the total required energy to transmit. RBs that cannot achieve the required minimum signal-to-interference-and-noise ratio (SINR) are given a score of infinity and are hence not allocated. Conflicts are resolved by calculating the energy efficiency scores for all users, and allocating the conflicting RBs to the users who can use them most efficiently. The rest of the conflicting users are allocated their next best resource. Consider the example in FIG. 2, which illustrates how fairness is promoted within the scheduling algorithm. The y-axis in FIG. 2b plots the required transmit power to achieve a certain SINR at the particular user. One user (user 2) is severely disadvantaged by the combination of path gain and interference, as shown in FIG. 2a. The two users happen to have the same RB as their best one (which corresponds to the lowest score in (1)) denoted by 1. The system then allocates this resource to the user who can use it more efficiently of the two, Rx₁. The penalty of that user will be increased so that in a similar conflict situation the resource will be given to the other user in contention. In the example, the second user is then allocated his next best available resource, which might be either 2 or 3.

The penalty function can be tailored to specific requirements. For example, it can take n, the number of already allocated RBs to the user, as input, and be of the form n² or even 2ⁿ. One can envision penalty functions that mimic the behavior of already popular schedulers such as proportional fair etc. The procedure is repeated until the QoS constraints within the base station (BS) are satisfied, or it is found that it is impossible to do so. At the end, a stable energy-efficient resource allocation is achieved.

The invention further involves trading bandwidth for energy efficiency. It has often been mooted that energy can be saved in wireless networks by trading bandwidth for spectral efficiency. However, to the best of our knowledge there is no concrete technique that describes how this finding is implemented in a real world system, or a detailed theoretical discussion of the expected gains.

The extended-bandwidth transmission mode of the invention is able to provide energy savings, since a channel's throughput is linearly proportional to the amount of bandwidth available, and only logarithmically proportional to the transmission power. The aforementioned is derived from the Shannon channel capacity equation:

$$C = B {log}_{2} ( 1 + \frac{S}{N + I} ) \qquad ( 2 )$$

where C is the channel capacity, B is the channel bandwidth, S is the total received signal power over the bandwidth, N is the total noise power, and I is the total interference power.

Thus, after running the score-based scheduler discussed above, the system checks if there are resources available that can be used to reduce the energy footprint of the current communication links. In case there are no free RBs, the allocation procedure is complete. However if there are resources available, the system proceeds to evaluate which users should be allowed to enter an extended-bandwidth transmission mode. The total bandwidth footprint of a user is expanded by a factor that is a natural number. Where the factor is a power of two, bandwidth expansion may be achieved by simply reducing the modulation alphabet. However when the coding rate (type of code used) is also varied, then the bandwidth expansion factor can be any natural number. Thus, the bandwidth expansion technique may involve adjusting link parameters other than modulation complexity, such as coding rate. This results in an energy saving if the channel conditions on the newly allocated RBs are comparable to the ones on the already used ones. The scheduling mechanism calculates if there will be such a saving. This is done using the energy metric employed in the score-based scheduler. The RBs to be additionally allocated are chosen based on their scores calculated using (1).

The user who is able to achieve the highest absolute energy reduction is allowed to enter the extended bandwidth transmission mode. That user is removed from the set of users considered for the next iteration of the algorithm. The process is repeated within the BS until there is no more bandwidth available, or no user can benefit from being allocated additional RBs. To achieve meaningful results, a power control routine is run concurrently with the allocation algorithm in the system.

To test the performance of the proposed scheduling algorithm, a simple 2-link simulation platform was developed. It is based on the LTE cellular mobile telephony system. It is used to compare three systems—one making use solely of the amended score-based scheduler, another making use of both the score-based scheduler and the bandwidth expanded transmission mode (BEM), and a third benchmark system that makes use of the widely-used proportional fair (PF) scheduling.

### Simulation Set-Up and Scenario

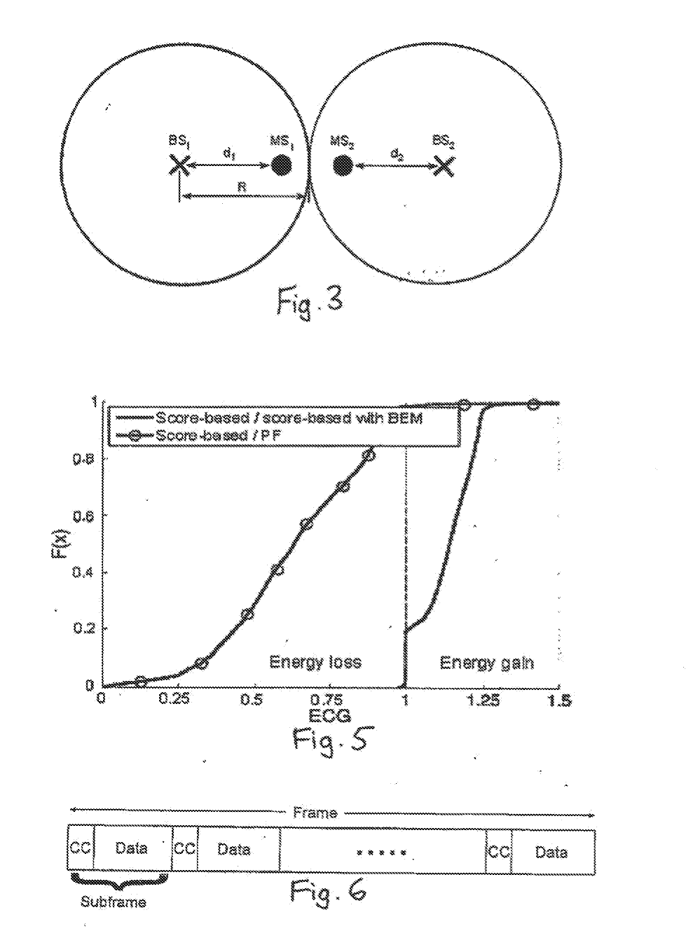

The set-up that is simulated can be seen in FIG. 3. It is a simple 2-link scenario that allows for the adjustment of three parameters—the two distances between receivers and transmitters, d₁ and d₂, and the transmitter radius, R, which controls the inter-site distance. Communication is carried out in the downlink direction.

The channel model used is the LTE urban micro-cell (UMi) (see 3GPP, “Further Advancements for E-UTRA Physical Layer Aspects (Release 9),” 3GPP TR 36.814 V0.4.1 (2009-02), September 2009. Retrieved Jun. 2, 2009 from www.3gpp.org/ftp/Specs/) as defined in Table 1, where d is the distance between transmitter and receiver, f_{c} is the carrier frequency in MHz, h_{BS} is the elevation of the base station (BS) antenna, h_{UT} is the elevation of the user terminal antenna, and d_{BP} is the propagation break point distance. In practice one of the three path loss equations is selected, based on d.

TABLE 1
Channel Model

| | Path Loss [dB] | St. dev [dB] |
|---|---|---|
| LOS | L = 22 log₁₀(d) + 28 + log₁₀(f_{c}) | σ = 3 |
| | L = 40 log₁₀(d) + 7.8 − 18 log₁₀(h_{BS} − 1) − | σ = 3 |
| | 18 log₁₀(h_{UT} − 1) + 2 log₁₀(f_{c}) | |
| NLOS | L = 36.7 log₁₀(d) + 22.7 + 26 log₁₀(f_{c}) | σ = 4 |

The rest of the system parameters are taken as prescribed in the LTE Advanced documentation, and can be found in Table 2.

TABLE 2
System Parameters

| Parameter | Value |
|---|---|
| Total Bandwidth | 18.75 MHz |
| Carrier Frequency | 2 GHz |
| Resource Bandwidth | 375 kHz |
| Number of Resource Blocks (RBs) | 50 |
| Subcarriers per RB | 8 |
| Noise Floor | −178.23 dBm |
| BS Maximum Power | 46 dBm |
| User Speed | 3 m/s |
| SINR targets, Γᵢ | 3.7 dB |
| Data rates | 1, 2 bits/symbol |
| Resources per User, x | 8 |
| Inter-site distance | 200 m |
| User 1 distance | 50 m |
| User 2 distance | 50 m |
| Bandwidth expansion factor, α | 2 |

Since the scheduler is the main focus of the simulation, the implementation pseudo-code is presented in Algorithm 1. Once the amended score-based scheduler achieves a stable allocation i.e. after a few time slots, the bandwidth expansion routine found in Algorithm 2 is run. Two system performance parameters are used for evaluation—data rate, and energy consumption gain. Energy consumption gain (ECG) is a comparison between two systems where E₁ is taken as the reference system: ECG=E₁/E₂. It is used to compare the performance of the two systems.

Algorithm 1 - Amended score-based scheduler

INITIALIZE the number of required RBs for each user
while Users require RBs do

CALCULATE scores for all users based on the energy metric and
score equation
for i = 1 to number of BSs do

FIND each user's best RB for the ones connected to this BS
if User's best RB is not allocated AND is usable AND is not
another user's best RB then

ALLOCATE RB to user

end if
if There were conflicting RBs between users then

RESOLVE conflicts by allocating RB to most efficient
user, and allocate next best RBs to the remaining users

end if

end for
if There are no available RBs for allocation OR no users require more
RBs then

EXIT while loop

end if

end while
RUN power control algorithm

Algorithm 2 - Bandwidth expansion routine

while There is available bandwidth do

CALCULATE scores for all users based on the energy metric and
score equation
FIND how much the system can benefit in absolute energy terms
from expanding each user's bandwidth
FIND the user for each BS who can benefit the most while not
hurting the overall network efficiency
ALLOCATE the required RBs to the best users

end while
RUN power control algorithm

### Results

The simulation platform was run with the aforementioned scenario and parameters. The results presented here are averaged over 1000 random channel realizations.

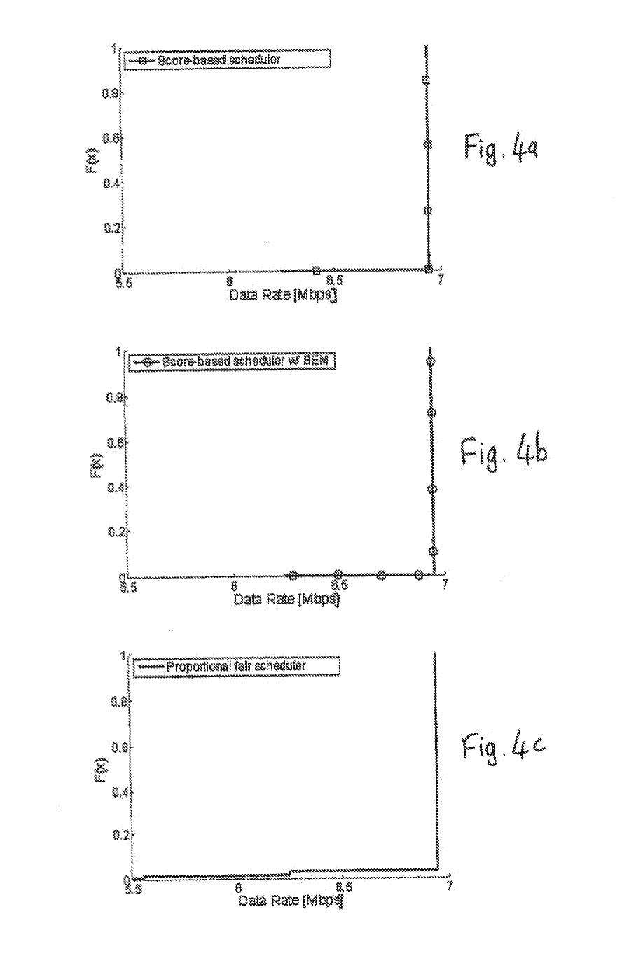

The data rate results are presented in FIGS. 4a, 4b and 4c. All systems behave very similarly. The PF system exhibits very slight service degradation for a small percentage of the users. The combination of fixed SINR target and number of RBs required per user result in the fixed/constant data rate achieved for all systems. Any deviation from that value is due to an incomplete allocation i.e. a lack of usable RBs or a failure to allocate such.

The cumulative distribution function of ECG is plotted in FIG. 5. The region to the right of ECG of 1 means that the evaluated system performs better than the benchmark (in this case, the score-based scheduling system). The performance advantage of the hereby proposed score-based scheduling system is immediately apparent. The PF system performs significantly poorer for about 98% of the time. At the 50^{th} percentile, it performs approximately 1.8 times worse than the proposed system. The system with BEM transmission capabilities further improves on the performance of the score-based system.

The simulation results provide empirical evidence that the proposed system is able to enhance energy efficiency. This is done at no cost to the delivered QoS to the users. A reduction of almost 50% in expended energy is achieved as compared to the benchmark PF system.

### Energy Metrics in Energy-Efficient Scheduling

It is clear that the energy metric that is used plays an important role in making scheduling decisions. In the above simulation results, the energy metric Eᵢ^{k}(t) denoted in (1) is calculated as the required RF energy for the data transmission. However, note that in general there are a number of ways to compute the Energy metric that may lead to different scheduler outcomes. There is a number of different forms of the energy metric Eᵢ^{k}(t) that can be used:
RF Energy for Data Transmission: In this case, the scheduler only considers the RF energy associated with the data that is being transmitted.
RF Energy for Data and Signaling Transmission: A second possible metric is the total RF energy consumption for delivering both the required control signaling and user data. As shown in FIG. 6, LTE control signaling generally includes reference signals for channel estimation, synchronization signals, broadcast channels, user specific resource assignments, etc., which can consume from 5-25% of total wireless resources in each radio frame. The control signaling also contributes a large amount of energy consumption, especially in the bandwidth expansion mode where user data consumes less RF energy. The use of this metric in conjunction with the blank subframe concept is described further in the next subsection.
Total Base Station Energy Consumption: A third option for the scheduler is to measure the total base station energy consumption to transmit the data under consideration. This requires a mathematical model that can convert the RF energy consumption and other parameters, such as the traffic load, into an equivalent energy consumption figure for the base station. This allows the scheduler to include the operational BS energy including for example power rectification, RF amplification, transceiver signal processing, base station cooling and so on.

Selecting an appropriate energy metric for scheduling depends on the network operator, however the computational complexity associated with the metric should be considered.

### Blank Subframe Concept

The use of energy metrics such as the RF energy for signaling and data transmission option above allows the scheduler to be applied to wireless systems that can exploit the blank subframe concept described in R. Wang, J. Thompson, and H. Haas, “A Novel Time-Domain Sleep Mode Design for Energy-Efficient LTE,” International Symposium on Communications, Control and Signal Processing, March 2010. With blank subframes, the system delivers all the user information within the active subframes while stopping the transmission of other subframes that contain no user data during a defined period of time. Energy savings can be obtained due to not transmitting control signaling in non-active subframes. Combining blank subframes into the energy-efficient scheduler of the present invention could further reduce the energy consumption.

Optimizing the number of blank subframes can easily be incorporated into our energy-efficient scheduling framework. The comparison of energy consumption in (1) for resource allocation determines how we select the best transmission option. The scheduler may thus consider different transmission modes which use different numbers of blank subframes. With the bandwidth expansion mode, this becomes even more important as the wider bandwidth may lead to an increased portion of control signaling. If this trade-off is to be optimized, the energy used for both the transmission of control and channel data for the subframes should be explicitly taken into account when making decisions to expand bandwidth or not within the scheduler to ensure the highest energy savings. Moreover, techniques such as transmission data aggregation could further improve the energy efficiency of a system that is able to employ blank subframes as well as extend bandwidth. In such a scenario, transmissions could be carried out only when it is necessary to satisfy the QoS, and hence maintain the best possible efficiency.

The invention is of particular interest when the wireless network is not fully loaded and when there are spare frequency resources available. For this scenario, the invention provides a novel scheduling algorithm which takes into account an energy efficiency metric in the scheduling process. In the past, the optimization criteria merely have been spectral efficiency and fairness. The scheduler of the invention addresses a third dimension, that is energy efficiency and the way this is leveraged is by exploiting the mechanism of expanding the bandwidth when it is available and at the same time using modulation schemes which require less power. The key advantage is that overall energy is reduced while QoS and throughput is retained. As mentioned above the scheduling mechanism of the invention can also work with other energy saving techniques, and even with multiple ones at the same time.

1. A method of operating a mobile telecommunications system having a base station, a plurality of users and a plurality of spectral resource blocks, some of which are not allocated to users, the method comprising (a) for each user, assigning a score to each resource block based on the energy efficiency with which the user can use the resource block, and determining which of the plurality of resource blocks is favored, i.e. has a score indicating that it will be the most energy efficient for the user; and for each user, either (b) if the user's favored resource block is not allocated, and is not favored by any other user, allocating that resource block to that user; or (c) in the event that the same resource block is favored by more than one user, allocating it to the user who will use it with the greatest energy efficiency.

2. A method according to claim 1, wherein calculation of the energy efficiency in step (a) comprises calculating the transmission power.

3. A method according to claim 1, wherein calculation of the energy efficiency in step (a) comprises calculating the energy per transmitted bit.

4. A method according to claim 1, wherein calculation of the energy efficiency in step (a) comprises calculating the total required energy for a transmission.

5. A method according to claim 1, including repeating steps (b) and (c) until either (i) all of the resource blocks have been allocated or (ii) all user quality-of-service constraints have been satisfied and no user's energy efficiency would be increased by a further resource block.

6. A method according to claim 1, wherein resource blocks that cannot achieve a minimum signal-to-interference-to-noise ratio (SINR) are removed from consideration in step (a).

7. A method according to claim 1, wherein a penalty function of each user is changed whenever the user is allocated a further resource block, the penalty function being used to modify the score and reduce the chance of that user being allocated further resource blocks.

8. A method according to claim 7, wherein the penalty function comprises a power of the number of resource blocks already allocated to the user.

9. A method according to claim 7, wherein the penalty function comprises a constant raised to the power of the number of resource blocks already allocated to the user.

10. A method according to claim 1, further comprising the steps of (p) determining whether there are free resource blocks; (q) if so, recalculating the scores for the free resource blocks according to step (a); (r) determining which of the users would increase the overall system energy efficiency most if the user's bandwidth were expanded; (s) determining that user's additional favored resource block(s) using the score recalculated in step (q); and (t) allocating the additional favored resource block(s) to the user and causing the user to enter an extended-bandwidth transmission mode.

11. A method of operating a mobile telecommunications system having a base station, a plurality of users and a plurality of spectral resource blocks, the method comprising (p) determining whether there are free resource blocks; (q) if so, assigning a score to each resource block based on the energy efficiency with which the user can use the resource block, and determining which of the plurality of resource blocks is favored, i.e. has a score indicating that it will be the most energy efficient for the user; (r) determining which of the users would increase the overall system energy efficiency most if the user's bandwidth were expanded; (s) determining that user's favored resource block(s) using the score calculated in step (q); and (t) allocating the additional favored resource block(s) to the user and causing the user to enter an extended-bandwidth transmission mode.

12. A method according to claim 11, wherein step (t) includes expanding the user's total bandwidth by a factor that is a natural number and reducing the user's modulation complexity accordingly.

13. A method according to claim 12, wherein step (t) additionally includes manipulating at least one other link parameter of the user.

14. A method according to claim 11, wherein the user entering extended-bandwidth transmission mode is removed from consideration for a subsequent bandwidth expansion.

15. A method according to claim 11, wherein steps (p) to (t) are repeated until step (p) finds that there are no more free resource blocks.

16. A method according to claim 1, including a power control routine which minimizes the signal strength allocated to each channel.

17. A method according to claim 16, wherein the power control routine is performed after step (c).

18. A method according to claim 11, including a power control routine which minimizes the signal strength allocated to each channel

19. A method according to claim 18, wherein the power control routine is performed after step (t).

20. A method according to claim 1, wherein signaling data is not transmitted during at least one subframe in which user data is not transmitted.

21. A base station adapted to perform the method of claim 1.
